(19) United States
(12) Patent Application Publication
(10) Pub. No.: US 2012/0192147 A1
(43) Pub. Date: Jul. 26, 2012

(54) Develop real time software without an RTOS

(76) Inventor: Argen Wong, Rodeo, CA (US)

(21) Appl. No.: 13/374,824

(22) Filed: Jan. 17, 2012

Related U.S. Application Data
(60) Provisional application No. 61/461,896, filed on Jan. 25, 2011.

(51) Int. Cl. G06F 9/44

(52) U.S. Cl. 717/106

(57) ABSTRACT

A method for creating time sensitive software or Real Time programs that are not controlled by and/or don't run under a Real Time Operating System (RTOS), or any type of Operating Systems. The invention described replaces the usage of a RTOS, such as vxWorks, Windows CE, RTLinux.

### RELATED APPLICATION

This application claims priority to U.S. Provisional Patent Application No. 61/461,896, filed Jan. 25, 2011, entitled “Develop real time software without an RTOS”

### BACKGROUND OF THE INVENTION

This invention describes a new concept of a “Task”, and how a Processor's Interrupt Mechanism (IM) is utilized in conjunction with Tasks to create a Real Time program that isn't controlled by and/or doesn't run under a Real Time Operating System (RTOS).

### SUMMARY OF THE INVENTION

A Processor and its resident software/firmware is an application-specific computer system, which could be “embedded” in a product or a standalone computer interfacing to an external product. An embedded product could be but is not limited to being a cell phone, a toy, a household appliance, test equipment, a Global Positioning System (GPS) device, aircraft avionics, or an automotive controller. An application-specific computer system is designed to monitor, control and/or perform specific functions associated with the product. If these described functions are time-sensitive, a Real Time (application) program needs to be created. Normally a Real Time program is created to run with and under the control of a RTOS inside a Processor. Any application program designed to meet time sensitive requirements is generally called a Real Time program. This invention describes how a Real Time program can be designed without a RTOS.

By eliminating a RTOS many cost savings can be realized, such as no need to purchase a RTOS, software developers with RTOS skills and experience are no longer needed, and RTOS software development tools are not needed. Further cost savings by not using a RTOS in a Real Time Program are: (1) a smaller (Processor) memory footprint, (2) faster response time to Real Time events, and (3) lower Processor usage. Thus a slower Processor with less memory may be used when implementing Real Time Software using this method.

The cost saving of not using a RTOS also translate to lowering the risk of a project, in particular, the project schedule and deadlines. When a RTOS is used, there is a learning curve of the RTOS itself and its debugging tools. Even if experience personnel are hired to minimize these problems, the RTOS itself may have problems that are not yet realized due mainly to lack of maturity. When these problems are compounded with other problems such as a developing Application program and/or problems with debugging tools, the risk to a project increases significantly.

This method (invention) could be used to create both, time critical (time sensitive) software and non-time critical software.

This invention (Method) uses a Processor's Interrupt Mechanism (IM) and a new concept of a Task to describe how a Real Time program can be created. This Method describes; (a) how a Processor's IM is used to assist in processing events as they occur in real time, (b) what a “Task” is, and its application rules, and (c) how to utilize Tasks in conjunction with the Processor's Interrupt Mechanism to create a Real Time program. The details of these three parts will be described in the Detail Description section.

### BRIEF DESCRIPTION OF THE DRAWINGS

Some figures contain a box with dash lines (such as shown in FIG. 5). Such box indicates that a designer/user can insert additional code here and/or that code is required in accordance to the product requirements. Product requirements are system- and design requirements for a particular product such as a GPS device, a toy, or an automotive controller.

FIG. 1 is a drawing showing that Task Priorities match the IM Interrupt Priorities.

FIG. 2 is a State Diagram showing four states that a Task could enter, which are general Task states for RTOS Tasks. The states are “Running”, “Not Running”, “Delay” and “Waiting.”

FIG. 3 is a block diagram of the Task Info Table that keeps track of each Task's information as they run in a Processor.

FIG. 4 is block diagram of a FIFO Wait Queue that keeps track of any Task waiting for data/resource.

FIG. 5 is a flowchart of the main function that initializes the Processor and data after power is applied or after a reset. This main function applies only when a Processor's IM interrupt priorities levels match the Task priorities.

FIG. 6 is a generic flowchart template for a Task that performs no delay and no waiting for any data/resource.

FIG. 7 is a generic flowchart template for a Task that also performs a delay and no waiting for any data/resource.

FIG. 8 is a generic flowchart template for any Task that also waits for data/resource, but no delaying.

FIG. 9 is a flowchart of an ISR for a delay timer use by a Task that requires delaying.

FIG. 10 and FIG. 100 are flowcharts of an ISR that will be invoked periodically by a timer interrupt. The purpose of this ISR is to check the wait condition of Tasks periodically.

FIG. 11 is a State Diagram showing three states that a Task could enter. The states are “Running”, “Not Running”, and “Waiting.”

FIG. 12 is a State Diagram showing three states that a Task could enter. The states are “Running”, “Not Running”, and “Delay”

FIG. 13 is a State Diagram showing two states that a Task could enter. The states are “Running”, and “Not Running.”

FIG. 14 is a flowchart of the main function that initialize the Processor and data after power is applied or after a reset. This main function applies only when a Processor's IM interrupt priorities levels match the Task priorities, and that Tasks do not enter the “Waiting” and “Delay” states.

FIG. 15 is a drawing showing that Task Priorities don't match the IM Interrupt Priorities.

FIG. 16 is a block diagram of the Task Info Table that keeps track of each Task's information as they run in a Processor. This Table contains the “Task Ready” flags.

FIG. 17 is a block diagram of the Task Arbiter Context buffer. This buffer holds information about the Task Arbiter.

FIG. 18 is a block diagram of a “Current Running Task” buffer. This buffer holds the Task ID of the Task that the CPU is currently executing.

FIG. 19 is a flowchart of the main function that initializes the Processor and data after power is applied or after a reset. This main function applies only when a Processor's IM interrupt priorities levels don't match the Task priorities.

FIG. 20 is a flowchart of Task Arbiter that determines which is the highest priority Task that is ready to run, and then runs it.

FIG. 21 is a generic flowchart. This flowchart logic shall be duplicated in each ISR. If there is “x” number of ISR in a Processor, then this flowchart logic shall be duplicated “x” times. This flowchart applies to a Processor that has interrupt priorities levels NOT matching the Task priorities.

FIG. 22 is a generic flowchart template for each Task in a Processor that has interrupt priorities levels NOT matching the Task priorities.

### DETAILED DESCRIPTION

The term “Processor” used in this document means the following: a computer, Embedded System, Embedded processor, Micro Controller Unit (MCU), Programmable Logic Controller (PLC), Programmable Controller, Single Board Computer (SBC), an Embedded Computer, computer in a chip, or any computing unit similar to the ones described.

It is assumed that a Processor has either a built-in Interrupt Mechanism or an external Interrupt Mechanism (IM) that it communicates with and access.

It is assumed that a Processor's IM is of priority base preemptive type, which is generally the case. This means that when a higher priority interrupt is detected by the Interrupt Mechanism, it will preempt a lower priority Interrupt Service Routine (ISR) that is currently running (or preempt non-ISR software that is currently running), unless interrupts are disabled or that higher priority interrupts are masked (inhibit).

(a) One of the two main keys to this invention is the utilization of a Processor's IM to assist in processing events as they occur in real time or processing time critical events. A designer using this method could setup each event to drive/signal an interrupt. The Processor's Interrupt Mechanism will determine which event caused a particular interrupt and selects a pre-defined ISR to process that event. Ideally or “Best Mode” the priority of each event is matched to the interrupt priority level (in the Interrupt Mechanism). This means that the highest priority event drives the highest priority interrupt, and the next highest priority event drives the next highest priority interrupt, and so forth. The designer or the product requirement determines the priority of each event. If an Interrupt Mechanism allows interrupt priority levels to be changed, such as via hardware setting and/or software programming, then changing the interrupt priority levels to match the events priorities will offer the “Best Mode” when applying this Method. If an IM doesn't allow it interrupt priority level to be changed and the IM's current interrupt priority levels don't match the priority levels of the events, this Method will still work as later described in the DETAIL DESCRIPTION.

Ideally it is faster to respond to an occurrence of an event when that event generates an interrupt directly to the IM. In lieu of generating an interrupt, an event can write into memory, set a flag or a bit in a register for examples. In this indirect approach, a Task will have to poll for the occurrence of an event. Polling can be accomplished (but not limited to) by using a timer interrupt that occurs periodically; the interrupt will invoke that Task to check for an occurrence of an event.

(b) In RTOS, a Task is defined as a thread or “a thread of execution”, that is created at runtime by RTOS, and exist only during runtime. In this patent, a Task is defined as software code; more specifically, a Task is a non-shared segment of code, which means no other caller or Task can traverse that particular segment of code. Unlike an RTOS Task, a Task described here is not created at runtime; a Task is not created by RTOS, and a RTOS is not needed to manage this Task. From here forward, a Task created to run under a RTOS will be called “RTOS Task.” The new Task described in this invention will be called “Task.”

A subroutine can be a Task if its entire code segment is a non-shared segment of code. An ISR can be a Task if its entire code segment is a non-shared segment of code.

If a subroutine is not a Task, and its code segment can be traversed by more than one Task, then that subroutine must have interrupts disable or mask (inhibit) at its beginning and enable or unmask interrupt(s) at its end, just before subroutine returns to caller.

If a Task accesses any shared resource, it should disable or mask interrupts before accessing that shared resource, and enable or unmask interrupts after it finishes accessing that shared resource. A shared resource is anything that multiple Tasks can access.

A Task can be a periodic (scheduled) type Task or an aperiodic (unscheduled) type Task. A periodic Task could be driven by a timer with an interrupt. A periodic Task could be driven by an external interrupt occurring periodically.

A Task also performs one or more functions. Functions could be any of the following but are not limited to: processing an external event, manages Input/output (I/O) device, perform some calculation, respond to an interrupt, or poll for incoming data.

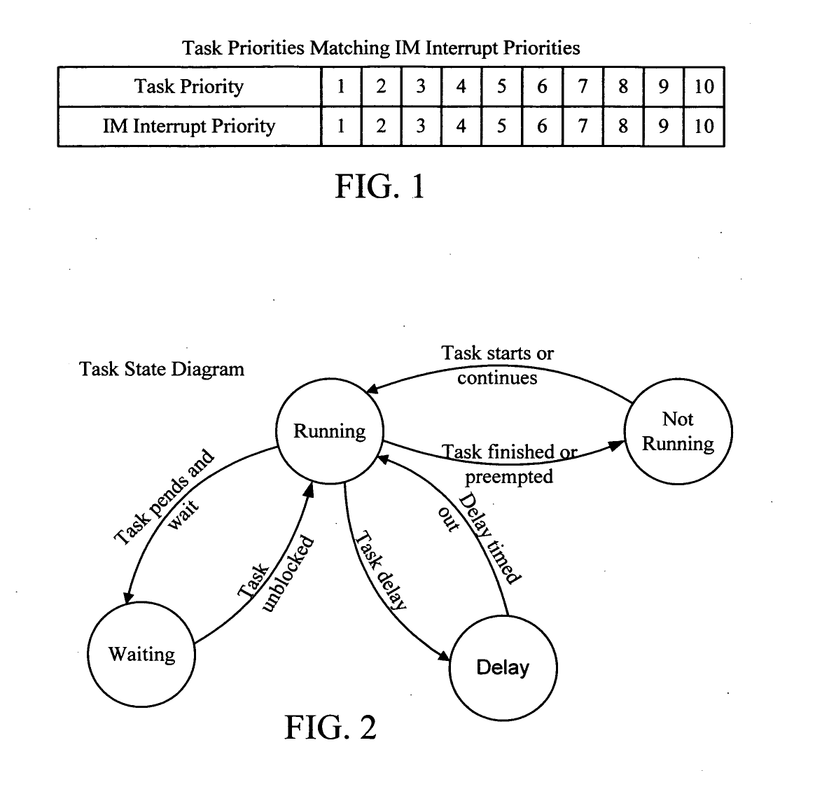

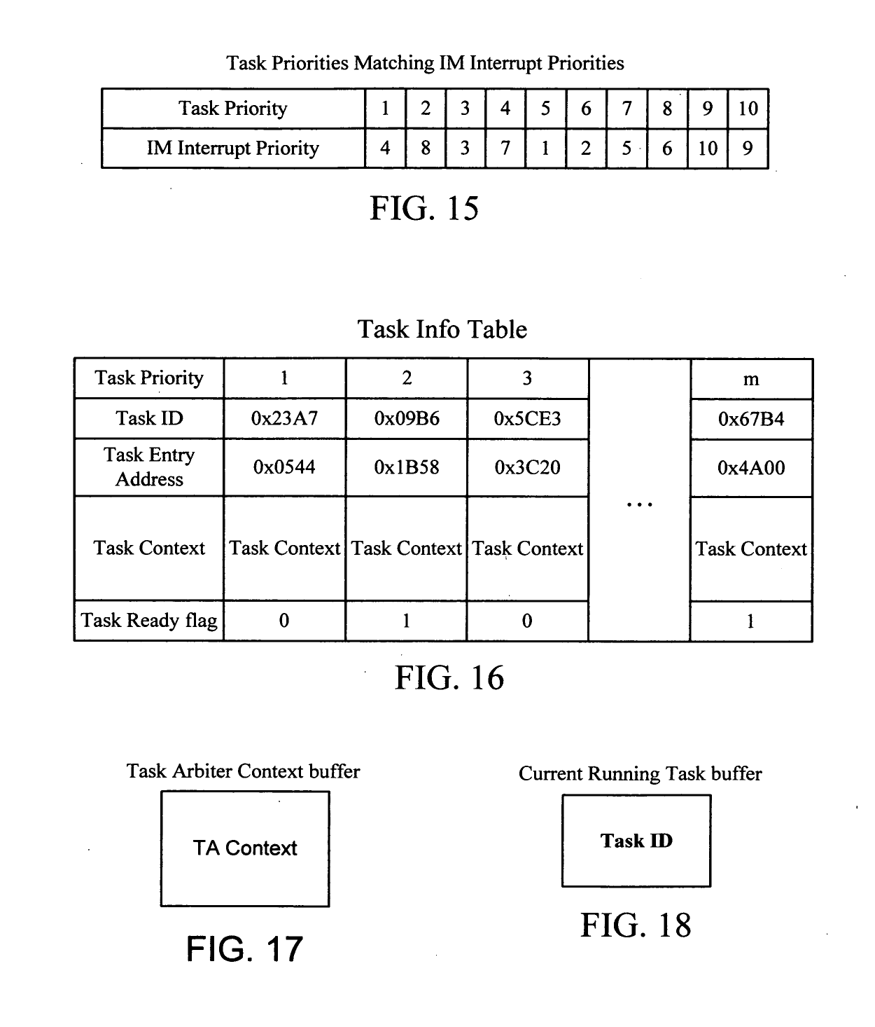

(c) The invention described here, utilizes Tasks in conjunction with the Processor's Interrupt Mechanism (IM) to create a Real Time program that isn't controlled by and/or doesn't run under a RTOS. The “Best Mode” configuration is when the Processor's IM interrupt priority levels matches the Task priorities as shown in FIG. 1. Less efficient configuration is when the Processor's IM interrupt priority levels don't match the Task priorities as shown in FIG. 15 as an example.

A Task is designed to process an event as it occurs in real time. These events can be internal and/or external to the Processor. An event causes an interrupt to occur in a Processor which in turn invokes a pre-programmed ISR to run. An ISR itself can be a Task or can invoke a Task to run. Using this method, an event could be setup to generate an interrupt to the Processor's IM, or an event could indicate its occurrence by writing data into memory and/or a register that a Processor can access. In order for a Task to detect an occurrence of an event that doesn't directly drive an interrupt, a Task could perform polling for that event. Polling could be accomplished using a timer with an interrupt, as an example. The Task that is polling for an event, setup a timer. When this interrupts occurs, the designated Task will check for the occurrence of its event.

It is desirable for a Processor to have the facility to allow software and/or via hardware settings to configure its interrupt priority levels to match Task priorities. For example, a clock timeout signal is connected to the Processor interrupt level #6, but the Task that processes clock timeout signal is required to run at priority level 3. If Processor's interrupt priority level can be changed from #6 to #3, it will match the required Task priority, thus yielding “Best Mode” configuration.

Even if a Processor doesn't have the facility to allow software and/or via hardware settings to configure its interrupt priority levels to match Task priorities, the “Best Mode” configuration can still be achieved, and that is when the Interrupt priority levels just happened to match the Task priorities in a Real Time program. Normally, this is an unlikely case.

Generally a Real Time program is divided into Tasks to manage and/or process various functions. A Task can be in any one of the four states shown in FIG. 2 while performing functions, which is the same case as RTOS Tasks. Method #1 described Tasks in these four states running with the “Best Mode” configuration. Method #1 is the “Best Mode” method because it emulates a Real Time program design to run with a RTOS.

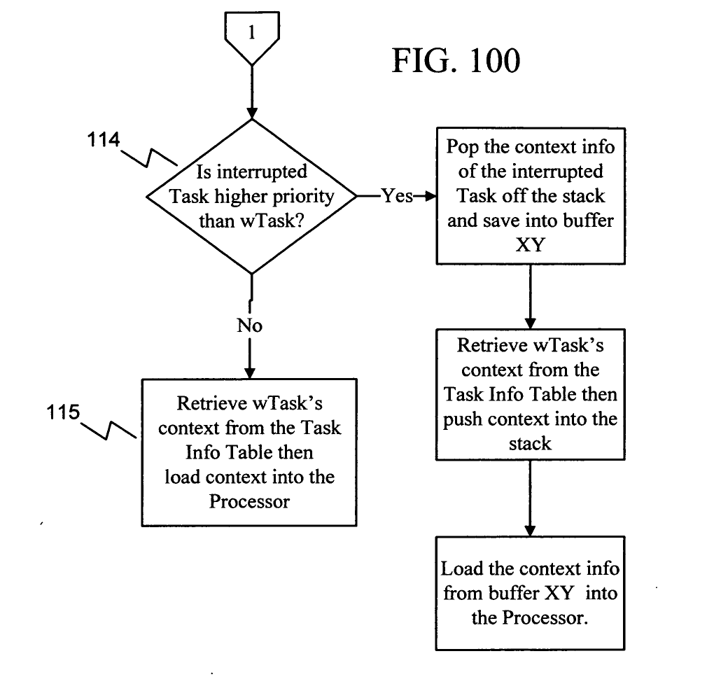

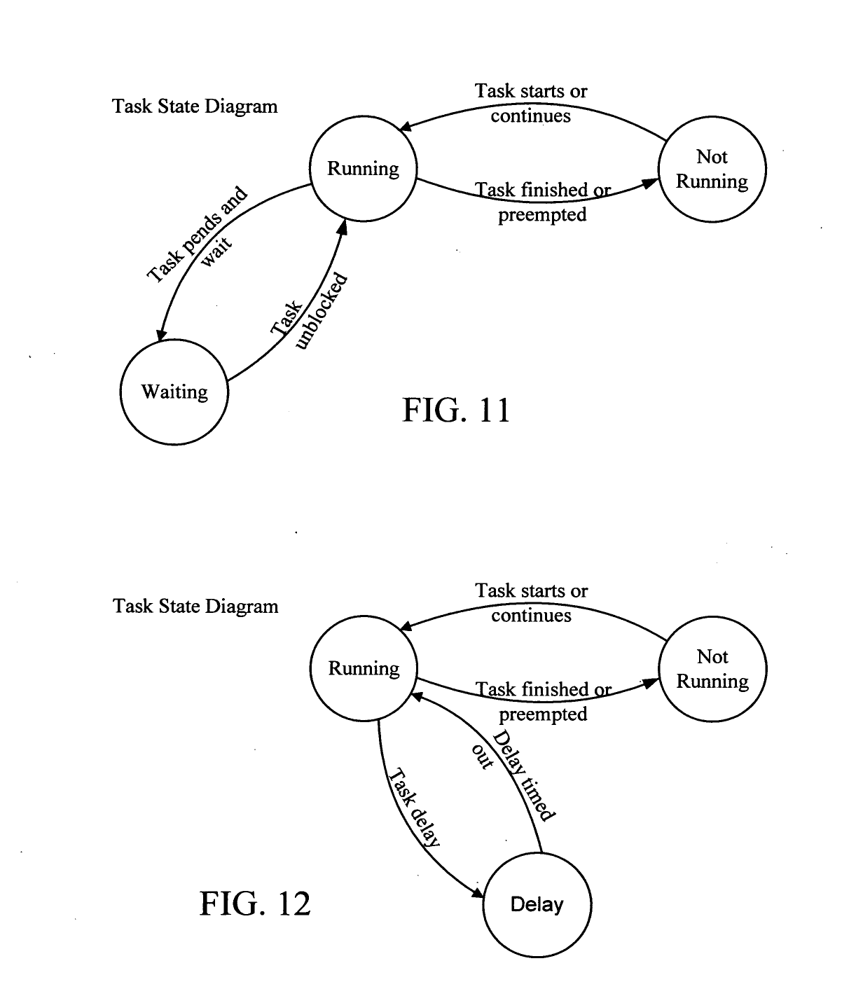

Method #1 can be scaled back if product requirements don't require Tasks to be in the delay and/or wait states (as shown in FIGS. 11, 12 and 13). These Methods are sub-methods of Method #1. These sub-methods are simpler (than Method #1) to use and yield greater efficiency than Method #1. If product requirements don't require any Task to delay (as shown in FIG. 11), then Method #1a can be applied. If product requirements don't require any Task to wait (as shown in FIG. 12), then Method #1b can be applied. If product requirements don't require any Task to wait and delay (as shown in FIG. 11), then Method #1c can be applied.

If the interrupt priority levels don't match the Task priorities (as shown in FIG. 15), the Processor's IM will still be used in conjunction with Tasks. However the Processor's IM will not be operating as a preemptive priority-based scheduler. The IM will receive the event driven interrupts and invoke ISRs, which in turn invokes a Task called the Task Arbiter (TA). The TA performs preemptive priority-based scheduling. This less efficient method shall be called Method #2.

Method #1 shall be described first, followed by its sub-methods (Methods #1a, 1b, and 1c). The less efficient Method #2 will be discussed toward the end.

The following figures apply to Method #1, they are FIGS. 1, 2, 3, 4, 5, 6, 7, 8, 9, 10, and 100. Method #1 can be used for creating a Real Time program. Its figures show all the necessary flow logic. A Real Time program can be created by using the figures as templates. Once a detailed set of flowcharts is created for a particular Real Time program that meets its product requirements, these flowcharts can be used for implementation (coding).

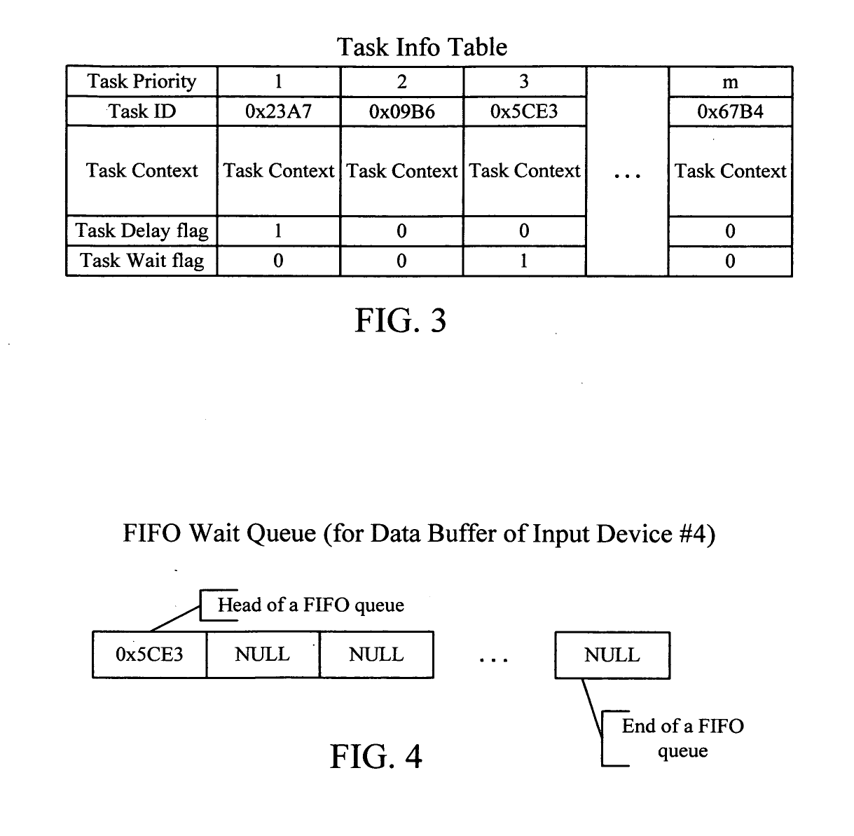

In Method #1, a Task can be in any one of the four states shown in FIG. 2; therefore, a Task Info Table (FIG. 3) is used to keep track of which state a particular Task is in as well as context information and Task information. There are five fields in the Task Info Table; they are: Task Priority, Task ID, Task Context, Task Delay flag, and Task Wait flag. Each column in the Task Info Table is reserved for a unique Task. Each Task is identified by a unique Task ID and a Task priority. The Task Context field holds Task context information which is the data and registers that Processor pushes into the stack prior to jumping into an ISR, comprise of, but not limited to the Program Counter (PC), Status register, Processor general registers. The Interrupt mask register is also saved in the Task Context field. If a Task enters a delay state, the Task Delay flag is set, else “0” or clear. If a Task enters a wait state, the Task Wait flag is set, else “0’ or clear.

Linked to each shared buffer and resource that a Task can access is a Wait Queue. When a Task is waiting for data from a buffer or for a resource, its Task ID will be place into this Wait Queue. FIG. 4 shows an example of a First-In-First-Out (FIFO) Wait Queue that this Method uses, but other types of Wait Queues may be used, such as a Priority Wait Queue, where the Task with the highest priority waiting is the first that gets the data or resource when available. FIG. 4 shows only Task ID 0x5CE3 is currently waiting for data from Input Device #4.

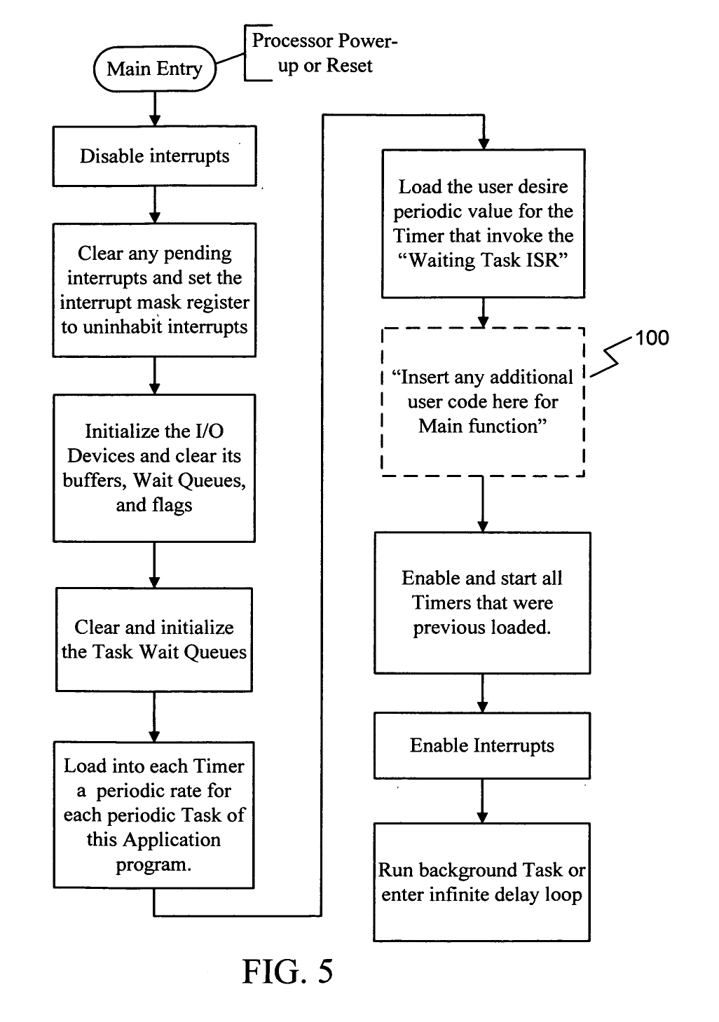

FIG. 5 is the main function for a Real Time program. This is the main entry of a Real Time program. Normally it is run after powering up the Processor or upon reset. The box with dash lines 100 indicates that a designer can insert additional code here and/or code required in accordance to the product requirements.

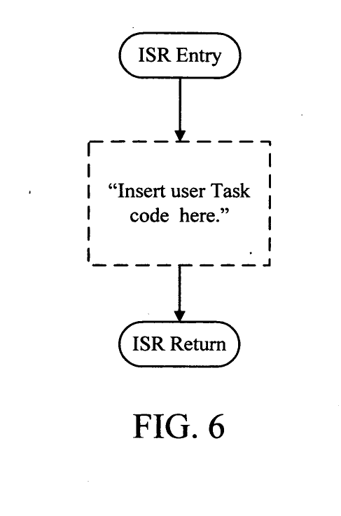

FIG. 6 is a flowchart template to use for creating a Task or any Task that performs no delay or wait for any data/resource. Here only product specific codes are required.

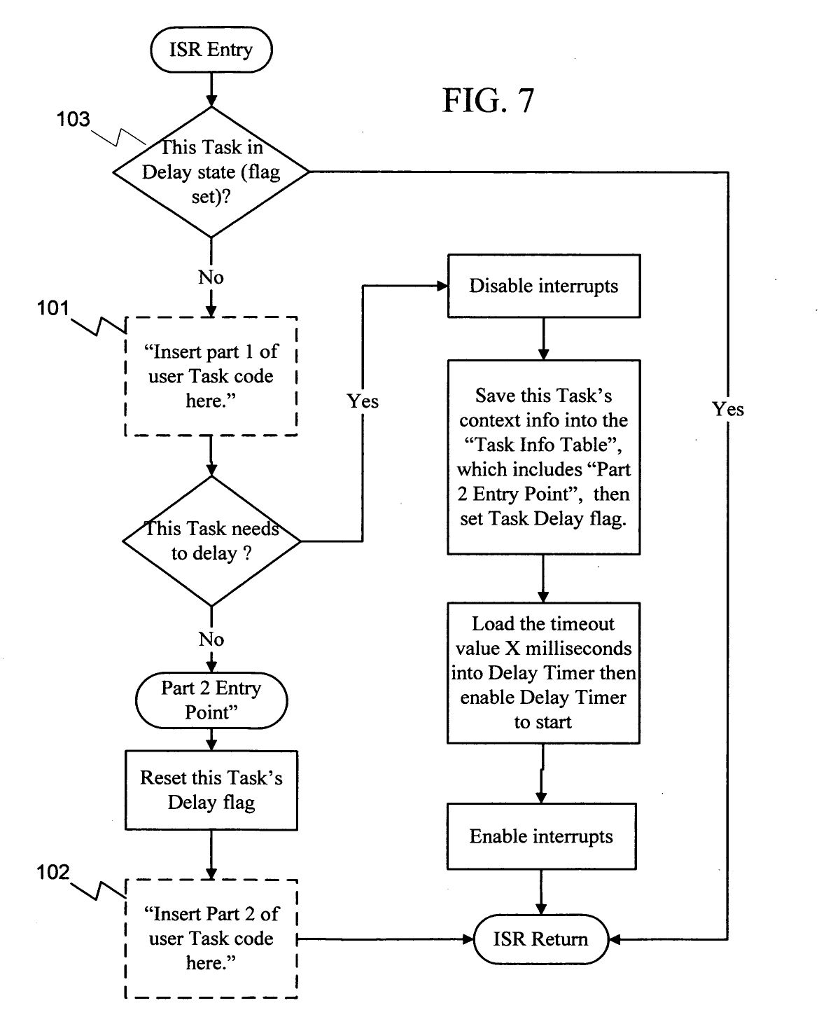

FIG. 7 is a flowchart template to use when creating a Task that doesn't enter the Wait state, but performs a delay. This flowchart shows a Task performing a delay of “X” milliseconds. Task uses a timer with interrupt to perform its delay. A timer can also be a virtual timer and doesn't have to be a physical timer. Each Task that performs delay(s) can have its own timer. The interrupt priority level of a delay timer is the same as its corresponding Task.

This flowchart shows only one delay, The user code (see boxes with dash lines) is divided into two parts; the first part of the code 101 runs until it wants to delay, and the second part 102 runs after the delay is finished. If a Task has two delays, then the user's code is divided into 3 parts, and the third part will run after the second delay. This logic repeats for each additional delay.

When an event occurs that invokes this Task, the Task checks 103 if itself is already in a Delay state. If Task is already in a Delay state, no further process is required as shown in this flowchart template.

The boxes 101 and 102 show the locations for product specific codes. Product specific codes are codes required in accordance to the product requirements.

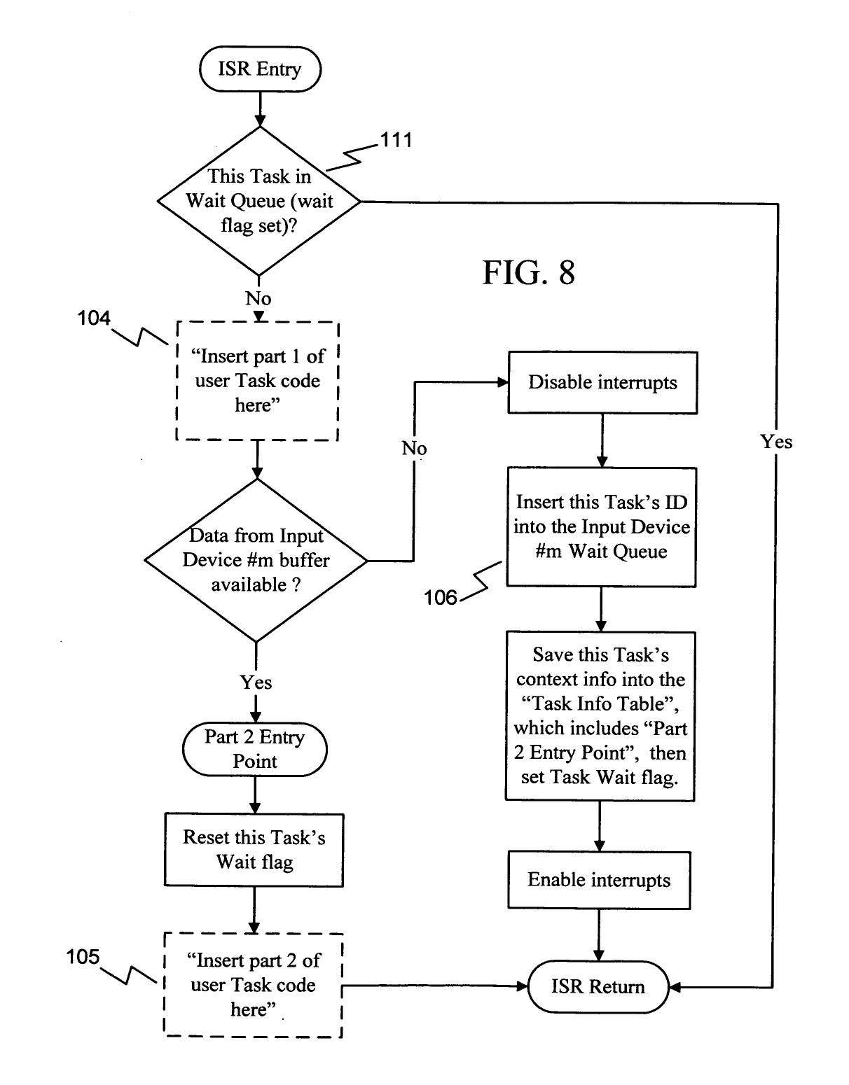

FIG. 8 is a flowchart template to use when creating a Task that doesn't enter the Delay state, but waits for data from Input Device #m. It can also be used to wait for another type of resource or data from a buffer. The user's code is divided into two parts (see boxes with dash lines); the first part 104 of the code runs until it requires data from Device #m. The second part 105 runs after data from Device #m becomes available. If a Task needs to wait for another Device #m+1, then the user's code is divided into 3 parts, and the third part will run after data from Device #m+1 becomes available. This logic repeats for each additional wait.

The boxes 104 and 105 show the locations for product specific codes. Product specific codes are codes required in accordance to the product requirements.

Input Device #m Wait Queue 106 is the same type of Wait Queue shown in FIG. 4.

The Logic shown in FIG. 7 and FIG. 8 can be used for a Task that enters into both the Wait state and the Delay state. The flow logic in FIG. 7 can be superimposed on the flow logic in FIG. 8 or vice-versa.

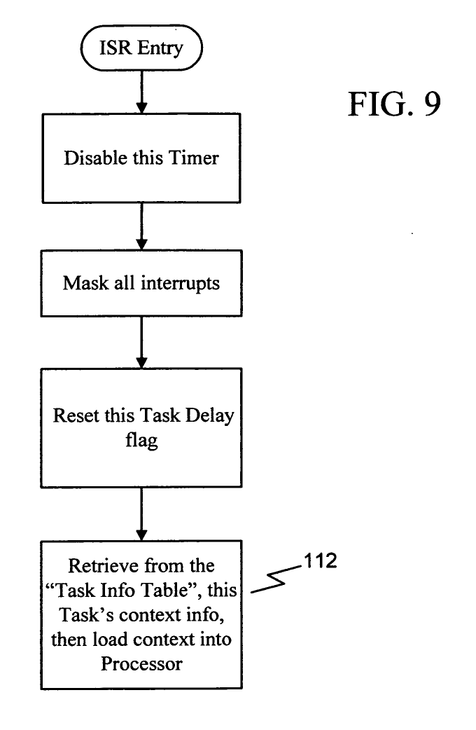

FIG. 9 shows a delay timer ISR. The Task that performs a delay, loads a time delay value into this delay timer as shown in FIG. 7. When that Delay timer times out, it will generate an interrupt which invokes this ISR (FIG. 9). FIG. 9 shows the design logic of an ISR that services that Delay Timer's interrupt, and how it returns to the delayed Task. In this method, each Task that requires delaying will be allocated an exclusive delay timer. A delay timer can be a physical timer or a virtual timer with a corresponding ISR.

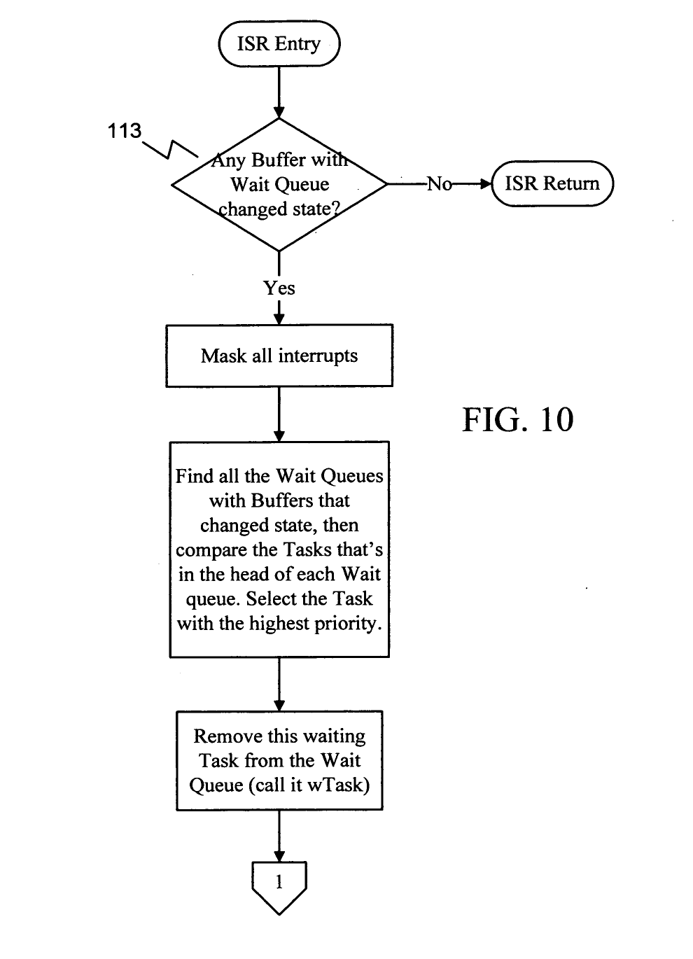

FIG. 10 and FIG. 100 show an ISR that service a periodic timer interrupt, which is used to manage Task(s) that are in the Wait state as shown in FIG. 8. When this periodic timer interrupt occurs, this ISR is invoked and checks for the highest priority Task that is no longer waiting for data/resource. Best to set this Timer interrupt to be as high or higher priority than the highest priority Task. This will ensure that when the highest priority Task is ready to run, it will run. The periodic rate for this timer is determined by the Designer and/or the product requirements; the slower the periodic rate, the longer a higher priority Task will have to wait before it can be run. However, if the periodic rate is set too fast, this ISR will consume much of the Processor time.

The following figures apply to Method #1a, they are FIGS. 1, 3, 4, 5, 6, 8, 10, 100, and 11. These figures contain all the necessary drawings and flowcharts for creating a Real Time program that has only these three states; they are: Running, Not Running, and Waiting (as shown in FIG. 11). The remaining figures were described previously.

The following figures apply to Method #1b, they are FIGS. 1, 3, 4, 5, 6, 7, 9, and 12. These figures contain all the necessary drawings and flowcharts for creating a Real Time program that have only these three states; they are: Running, Not Running, and Delay (as shown in FIG. 12). The remaining figures were described previously.

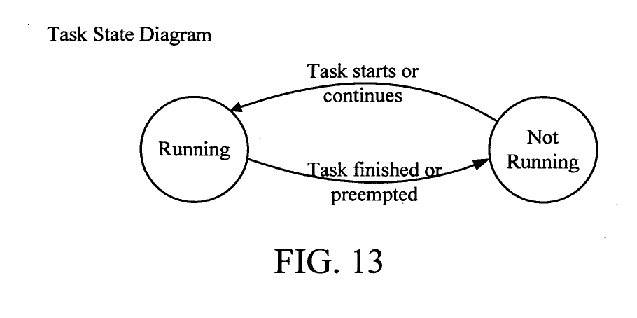

The following figures apply to Method #1c, they are FIGS. 1, 6, 13, and 14. These figures contain all the necessary drawings and flowcharts for creating a Real Time program that have only these two states; they are: Running, and Not Running (as shown in FIG. 13).

FIG. 1 and FIG. 6 have been described previously.

FIG. 13 shows a Task State Diagram containing only two states. If a Real Time program with Tasks running in only these two states is designed to run under an RTOS, the entire RTOS will still have to reside in Processor memory and run.

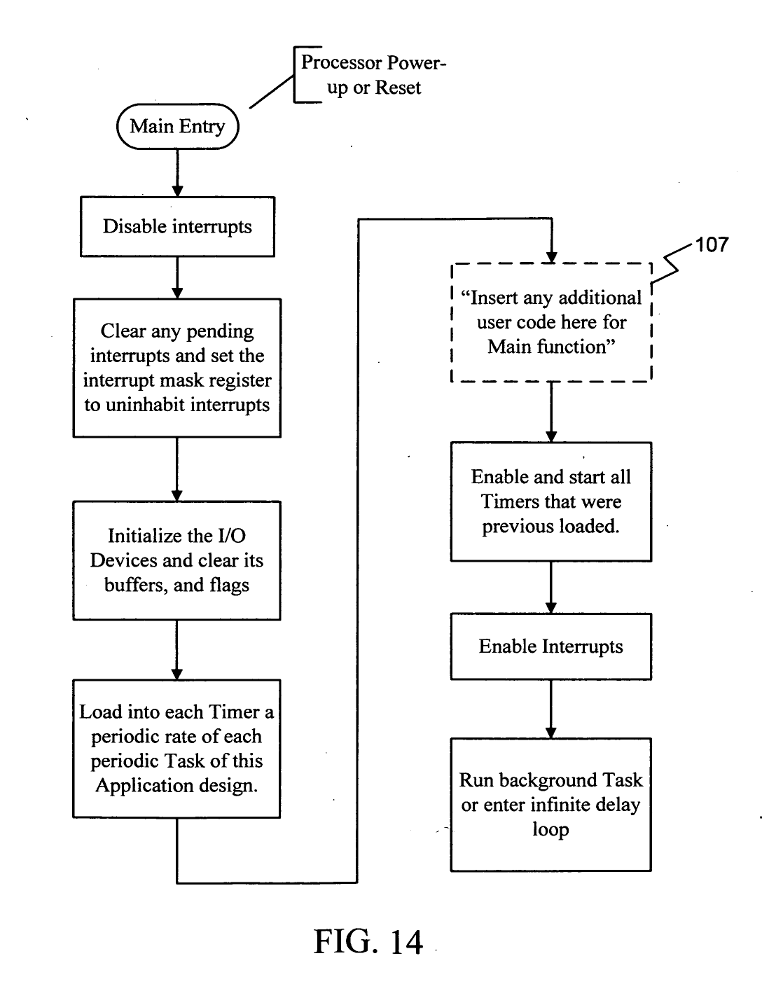

FIG. 14 is the main function of the Real Time program for Method 1c. This is the main entry of a Real Time program. Normally it is run after powering up a Processor or upon reset. The box 107 with dash lines indicates that a designer can insert additional code here and/or code is required in accordance to the product requirements.

The following figures apply to Method #2, they are FIGS. 13, 15, 16, 17, 18, 19, 20, 21, and 22.

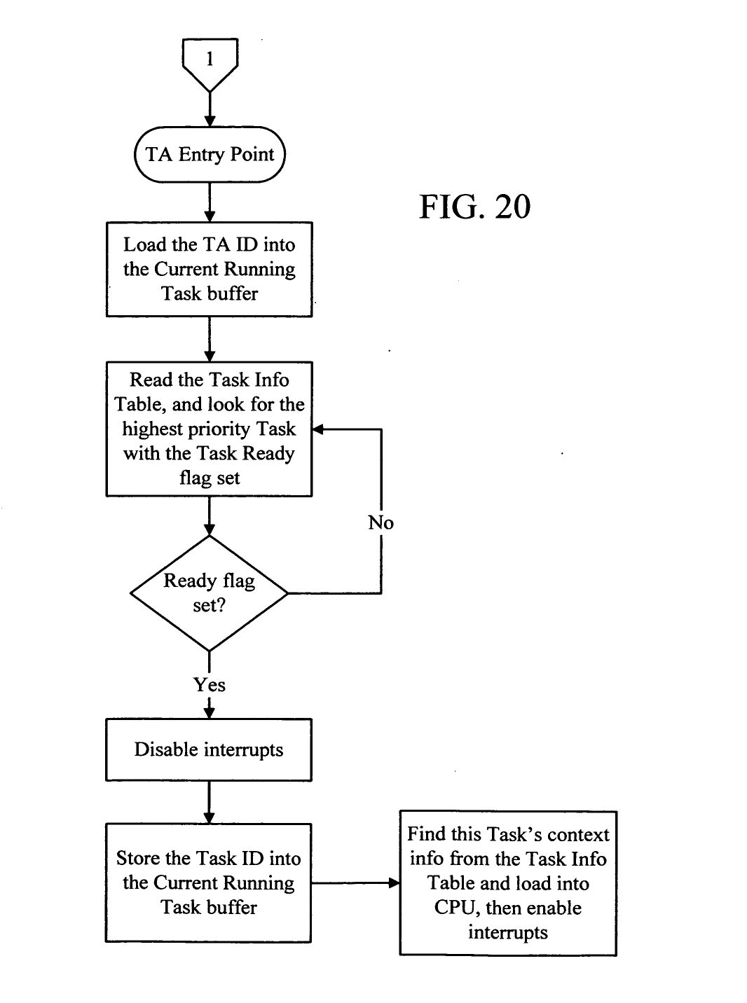

Method #2 shows that when the Processor's IM interrupt priority levels are not matched with the Task priorities, the Processor's IM cannot serve as preemptive priority-based scheduler. However, use of the IM and Tasks can still replace a RTOS. To achieve preemptive priority-based scheduling, a Task called “Task Arbiter” is used as shown in FIG. 20. Since the Task Arbiter is software, it is much slower than an IM, therefore is not the “Best Mode” method.

FIG. 15 shows a Processor's IM interrupt priority levels that don't match the Task priorities.

FIG. 16 is a Task Info Table. It is used to keep track of which state a particular Task is in as well as context information and Task information. There are five fields in the Task Info Table; they are: Task Priority, Task ID, Task Entry address, Task Context, and Task Ready flag. Each column in the Task Info Table is reserved for a unique Task. Each Task is identified by a unique Task ID, a Task priority, and a Task Start (entry) address. The Task Context field holds the data and registers data that Processor pushes into the stack prior to jumping into an ISR, which normally comprise of, but not limited to the Program Counter (PC), Status register, Processor general registers. The Interrupt mask register is not saved in the Task Context field. The Task Ready flag when set indicates to the TA that this Task is ready to run.

FIG. 17 is a buffer that holds the TA entry point (address), TA ID, and the TA's context information. It is the same type of information as a Task context as described in FIG. 16 above, with the Program Counter containing the TA entry point.

FIG. 18 is a buffer that holds the Task ID of the Task that is currently running. The Real Time program writes into this buffer, the Task ID of the Task that is currently running.

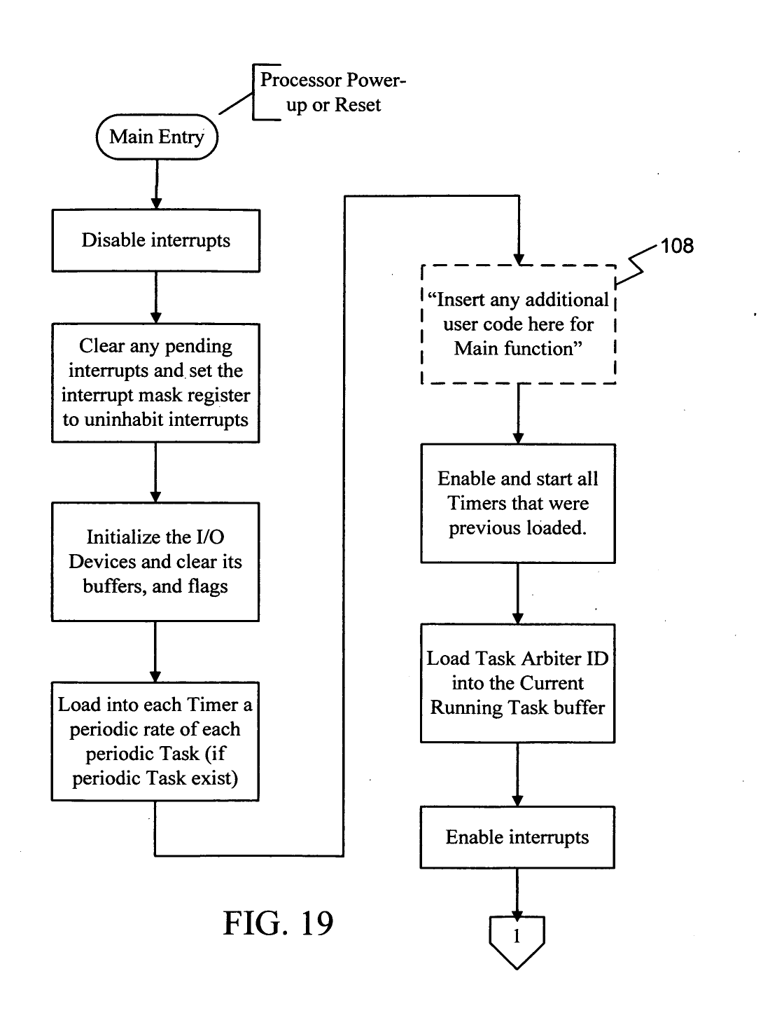

FIG. 19 is the main function of the Real Time program. Normally it is run after powering up a Processor or upon reset. The box 108 with dash lines indicates that a designer can insert additional code here and/or code is required in accordance to the product requirements.

FIG. 20 is a flowchart showing the Task Arbiter (TA). The TA searches for the highest priority Task that is ready to run, and then runs it. To perform this function it checks the Task Ready flags in the Task Info Table FIG. 16. If no Task is ready to run, then it just keeps searching.

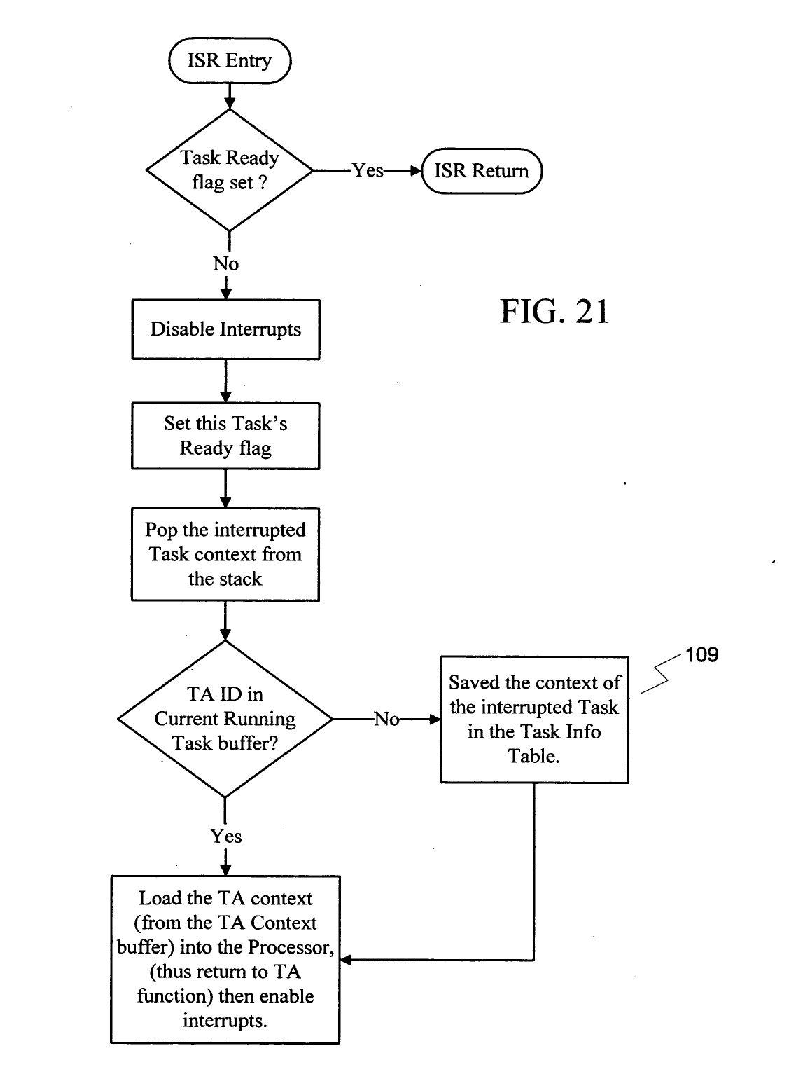

FIG. 21 shows the flow logic for an ISR. This logic shall be duplicated in each ISR that is part of a Task. The process box 109 can determine which Task was interrupted by reading the Task ID from the Current Running Task buffer. The Task ID is used to place the Task context information that was popped off the stack, and saved into the Task Context Table. Note that in this flowchart, there is no designer code or unique code for a particular Task.

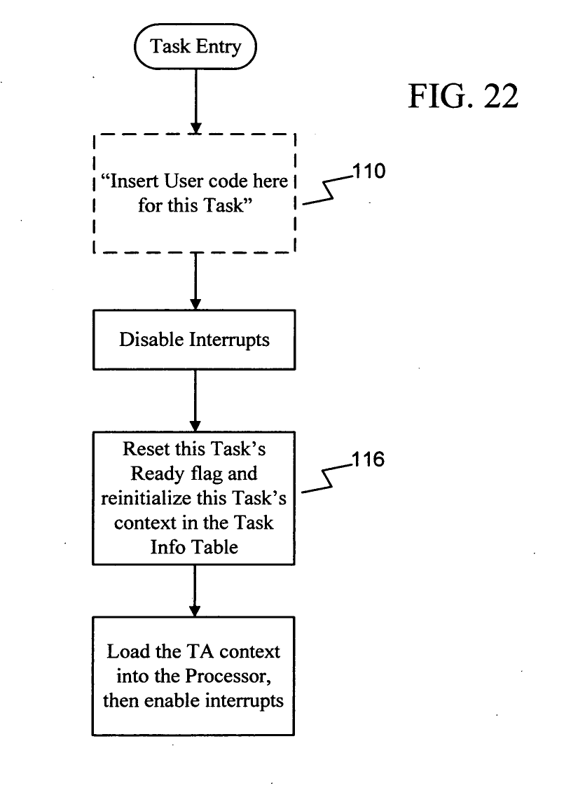

FIG. 22 shows a generic flowchart template for each Task's main body. Use this template to create each and every Task. The box 110 with dash lines indicates unique Task codes are place here.

Method #2 can be used to create any Real Time program that was created using Method #1c, but Method #1c cannot be used to create any Real Time program that was created using Method #2. Method #2 can be expanded for Tasks having all four states as in Method #1.

What is claimed:

1. A method for designing time sensitive software or Real Time programs that aren't controlled by and/or don't run under a RTOS or any type of Operating System. A RTOS will not be part of a Real Time program. This method describes a new concept of a Task, and how a Processor's Interrupt Mechanism (IM) is utilized in conjunction with Tasks to design Real Time software without the use of an RTOS.

2. The method of claim 1 wherein a Task is defined as software code, and specifically a non-shared segment of code, which means no other caller or Task can traverse that particular segment of code. A subroutine or an ISR can be a Task if its entire code segment is a non-shared segment of code. If a subroutine is not a Task, and its code segment will be traversed by more than one Task, then that subroutine must have interrupts disable or mask (inhibit) at its beginning and enable or unmask interrupt(s) at its end (just prior to returning to caller). If a Task accesses any shared resource, it should disable or mask interrupts before accessing that shared resource, and enable or unmask interrupts after it finished accessing that shared resource. A shared resource is anything that multiple Tasks can access. A Task can be a periodic (scheduled) type Task or an aperiodic (unscheduled) type Task. A periodic Task could be driven by a timer with an interrupt. A periodic Task could be driven by an external interrupt occurring periodically.

3. The method of claim 1 wherein a Processor's IM is also used as preemptive priority-based scheduler, which emulates the preemptive priority-based scheduler in a RTOS. The main function of a preemptive priority-based scheduler is that a higher priority Task will preempt a Task that is currently being run by the Processor, such that the Processor will then run the higher priority Task instead.

4. The method of claim 1 wherein the priority of each Task is match with the Processor's interrupt priorities, thus enabling the highest priority interrupt to invoke the highest priority Task. The next highest priority interrupts will invoke the next highest priority Task, and so forth.

5. When Task priorities cannot be matched to Processor's interrupt priorities. A Processor or an IM can be created to have a facility to allow software and/or via hardware settings to configure its interrupt priority levels to match Task priorities. By having this feature in a Processor or IM, the Interrupt priorities can be setup to match Task priorities in the following ways be not limited to: (a) via the software or firmware running inside the Processor. Software can be the Real Time program itself, and (b) via hardware settings. An example would be a set of jumpers that configure the IM to alter their interrupt priorities to match the Task priorities.

6. The method of claim 1 wherein the priority of each Task is not matched with the Processor's interrupt priorities; the Processor's IM will still be used in conjunction with Tasks. However the Processor's IM will not be operated as a preemptive priority-based scheduler. The IM will receive the event driven interrupts and invoke ISRs, which in turn invokes a Task to perform preemptive priority-based scheduling.

7. The method of claim 1 wherein a Real Time program runs faster and requires a smaller amount of Processor memory as compared to Real Time programs designed to run with a RTOS. The Processor's IM when operating as a preemptive priority-based scheduler responds faster than a RTOS, because the IM is hardware or hardwired whereas the RTOS is software. When a Real Time program is not linked with a RTOS or an RTOS is not loaded into Processor's memory along with the Real Time program during execution, it requires less memory.

8. The method of claim 1 wherein the understanding of the design of a Real Time program is easier. A Task unlike a RTOS Task is just software code. Code that can be physically seen when printed to a computer printer, whereas an RTOS Task is not code, but a thread or a thread of execution which only exists at runtime (when Processor runs).

9. The method of claim 1 wherein learning to debug/troubleshoot a Real Time program is easier because (a) A Task is software code and not a “thread of execution” as in a RTOS Task, (b) understanding of a RTOS or any RTOS is not required, and (c) there is no propriety real time software debugging tools to learn. Normally when a Real Time program is developed to running with a particular RTOS, the debugging tools must be designed to also work with that particular RTOS.

10. The method of claim 1 can also be used for non-time sensitive or non-time critical software design.
